(19) United States
(12) Patent Application Publication
(10) Pub. No.: US 2025/0016298 A1
(43) Pub. Date: Jan. 9, 2025

(54) DISPLAY APPARATUS, DISPLAY METHOD, AND NON-TRANSITORY RECORDING MEDIUM THAT STORES PROGRAM

(71) Applicant: JVCKENWOOD Corporation, Yokohama-shi (JP)

(72) Inventor: Hisashi OKA, Yokohama-shi (JP)

(21) Appl. No.: 18/888,215

(22) Filed: Sep. 18, 2024

Related U.S. Application Data
(63) Continuation of application No. PCT/JP2023/000851, filed on Jan. 13, 2023.

(30) Foreign Application Priority Data
Mar. 22, 2022 (JP) 2022-045632

(51) Int. Cl. H04N 13/368; G02B 30/52; G09G 3/02; H04N 13/395; H04N 13/398

(52) U.S. Cl. CPC H04N 13/368; G02B 30/52; G09G 3/02; H04N 13/395; H04N 13/398; G09G 2354/00

(57) ABSTRACT

A display apparatus includes: a display body in which a plurality of screens are layered, each of the plurality of screens including a plurality of pixels arranged in an in-plane direction, and each of the plurality of pixels being switchable between a transmission state and a diffusion state; an irradiation unit that radiates an image display light toward the display body; a sensor that detects positions of a plurality of observers with respect to the display body; and a control unit that synchronously controls switching between a transmission state and a diffusion state of each of the plurality of pixels of the plurality of screens and switching of a display content of the image display light radiated from the irradiation unit in accordance with the positions of the plurality of observers detected by the sensor.

### CROSS REFERENCE TO RELATED APPLICATION

This application is a continuation of application No. PCT/JP2023/000851, filed on Jan. 13, 2023, and claims the benefit of priority from the prior Japanese Patent Applications No. 2022-045632, filed on Mar. 22, 2022, the entire content of which are incorporated herein by reference.

### BACKGROUND

### 1. Technical Field

The present disclosure relates to a display apparatus, a display method, and a non-transitory recording medium that stores a program.

### 2. Description of the Related Art

A volume display configured to display a three-dimensional object as it is in space is known as a display apparatus for a three-dimensional image. For example, a configuration in which a projector light is output to a projection screen making a reciprocating motion has been proposed.
[Patent Literature 1] JP Patent 6716565

In volume displays, it is common to display an object such that the space inside can be seen through to allow an observer to observe the object from different points of view. When an actual non-transparent three-dimensional object is observed, however, the space inside cannot be seen through so that a difference from the actual appearance will be created.

### SUMMARY

The present disclosure addresses the issue described above, and a purpose thereof is to provide a technology of improving the appearance of a stereoscopic image displayed by a volume display.

A display apparatus according to an embodiment of the present disclosure includes: a display body in which a plurality of screens are layered, each of the plurality of screens including a plurality of pixels arranged in an in-plane direction, and each of the plurality of pixels being switchable between a transmission state and a diffusion state; an irradiation unit that radiates an image display light toward the display body; a sensor that detects positions of a plurality of observers with respect to the display body; and a control unit that synchronously controls switching between a transmission state and a diffusion state of each of the plurality of pixels of the plurality of screens and switching of a display content of the image display light radiated from the irradiation unit in accordance with the positions of the plurality of observers detected by the sensor. The control unit: identifies a first display portion in accordance with the position of a first observer of the plurality of observers and generates display image data for displaying the first display portion identified; identifies a second shielded portion, which constitutes at least a portion of the first display portion, in accordance with the position of a second observer of the plurality of observers and generates pixel pattern data that defines a position of a pixel in each of the plurality of screens in a diffusion state so that a pixel in a diffusion state is not located between the first observer and the first display portion and a pixel in a diffusion state is located between the second observer and the second shielded portion; controls the display content of the image display light radiated from the irradiation unit using the display image data; and controls switching between a transmission state and a diffusion state of each of the plurality of pixels of the plurality of screens using the pixel pattern data.

Another embodiment of the present disclosure relates to a display method. The method includes detecting, using a sensor, positions of a plurality of observers with respect to a display body in which a plurality of screens are layered, each of the plurality of screens including a plurality of pixels arranged in an in-plane direction, and each of the plurality of pixels being switchable between a transmission state and a diffusion state; and synchronously controlling switching between a transmission state and a diffusion state of each of the plurality of pixels of the plurality of screens and switching of a display content of an image display light radiated from an irradiation unit toward the display body in accordance with the positions of the plurality of observers detected by the sensor. The controlling includes: identifying a first display portion in accordance with the position of a first observer of the plurality of observers and generating display image data for displaying the first display portion identified; identifying a second shielded portion, which constitutes at least a portion of the first display portion, in accordance with the position of a second observer of the plurality of observers and generating pixel pattern data that defines a position of a pixel in each of the plurality of screens in a diffusion state so that a pixel in a diffusion state is not located between the first observer and the first display portion and a pixel in a diffusion state is located between the second observer and the second shielded portion; controlling the display content of the image display light radiated from the irradiation unit using the display image data; and controlling switching between a transmission state and a diffusion state of each of the plurality of pixels of the plurality of screens using the pixel pattern data.

Still another embodiment of the present disclosure relates to a non-transitory recording medium that stores a program. The program includes: a module that detects, using a sensor, positions of a plurality of observers with respect to a display body in which a plurality of screens are layered, each of the plurality of screens including a plurality of pixels arranged in an in-plane direction, and each of the plurality of pixels being switchable between a transmission state and a diffusion state; and a module that synchronously controls switching between a transmission state and a diffusion state of each of the plurality of pixels of the plurality of screens and switching of a display content of an image display light radiated from an irradiation unit toward the display body in accordance with the positions of the plurality of observers detected by the sensor. The module that controls includes: a module that identifies a first display portion in accordance with the position of a first observer of the plurality of observers and generates display image data for displaying the first display portion identified; a module that identifies a second shielded portion, which constitutes at least a portion of the first display portion, in accordance with the position of a second observer of the plurality of observers and generates pixel pattern data that defines a position of a pixel in each of the plurality of screens in a diffusion state so that a pixel in a diffusion state is not located between the first observer and the first display portion and a pixel in a diffusion state is located between the second observer and the second shielded portion; a module that controls the display content of the image display light radiated from the irradiation unit using the display image data; and a module that controls switching between a transmission state and a diffusion state of each of the plurality of pixels of the plurality of screens using the pixel pattern data.

Optional combinations of the aforementioned constituting elements, and mutual substitution of constituting elements and implementations of the present disclosure between methods, apparatuses, systems, etc. may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram schematically showing a configuration of a display apparatus according to the first embodiment;

FIG. 2 is a diagram schematically showing an exemplary configuration of the screen;

FIG. 3 is a block diagram schematically showing an exemplary functional configuration of the control unit;

FIG. 4 is a diagram schematically showing exemplary three-dimensional data;

FIGS. 5A and 5B are diagrams schematically showing examples of a display portion and a non-display portion;

FIG. 6 is a diagram schematically showing a method for generating cross-sectional image data;

FIGS. 7A, 7B, 7C, 7D, 7E, and 7F are diagrams schematically showing examples of cross-sectional images;

FIG. 8 is a flowchart illustrating an exemplary display method according to the first embodiment;

FIG. 9A is a display example of the stereoscopic image seen from the observer according to a comparative example, and FIG. 9B is a display example of the stereoscopic image viewed from the observer according to the embodiment;

FIG. 10 is a diagram schematically showing a configuration of a display apparatus according to the second embodiment;

FIGS. 11A, 11B, and 11C are diagrams schematically showing a display method according to the second embodiment;

FIG. 12 is a flowchart showing an exemplary display method according to the second embodiment;

FIG. 13 is a diagram schematically showing a configuration of a display apparatus according to the third embodiment;

FIG. 14 is a cross-sectional view schematically showing a display method according to the third embodiment; and

FIG. 15 is a flowchart illustrating an exemplary display method according to the third embodiment.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the present disclosure and should not be construed as limiting the present disclosure unless specifically indicated as such. Those elements in the drawings not directly relevant to the present disclosure are omitted from the illustration. To facilitate the understanding, the relative dimensions of the constituting elements in the drawings do not necessarily mirror the actual relative dimensions.

### First Embodiment

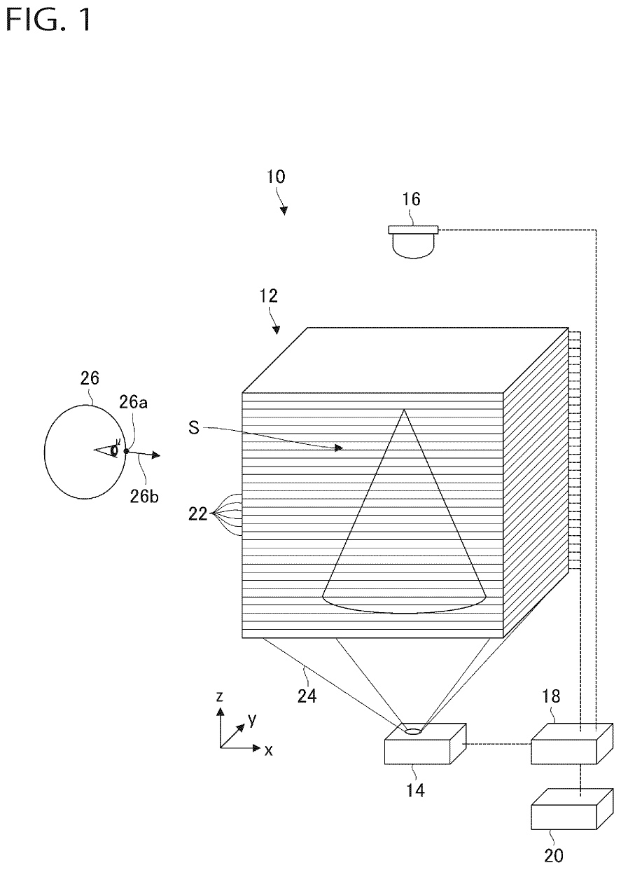

FIG. 1 is a diagram schematically showing a configuration of a display apparatus 10 according to the first embodiment. The display apparatus 10 includes a display body 12, an irradiation unit 14, a sensor 16, and a control unit 18. The display apparatus 10 is a so-called volume display and is configured to draw a stereoscopic image S inside the display body 12 using three-dimensional data provided by an external apparatus 20.

The display body 12 includes a plurality of screens 22 having a plate shape. The display body 12 is comprised of a plurality of screens 22 layered in a direction (z direction) orthogonal to the in-plane direction (x direction and y direction) of each of the plurality of screens 22. The display body 12 is configured to have a cylindrical shape, a polygonal prism shape, or a cuboid shape. The outline of each of the plurality of screens 22 is circular, polygonal, or rectangular. In the example shown in FIG. 1, the display body 12 has a cuboid shape, and the outline of each of the plurality of screens 22 is rectangular.

The number of the plurality of screens 22 does not particularly matter but can be, for example, 10 or more, 100 or more, or 1000 or more. The number of the plurality of screens 22 determines the resolution of the display body 12 in the z direction. On the other hand, the resolution of the display body 12 in the x direction and the y direction is determined by the resolution of an image display light 24 radiated from the irradiation unit 14.

The screen 22 is configured to be switchable between a transmission state that transmits light and a diffusion state that diffuses light. The transmission state means a state that is transparent to visible light and means a state in which an incident visible light is transmitted as it is, and an incident visible light travels straight without being scattered. On the other hand, the diffusion state means a state in which an incident visible light is scattered and means a state in which an incident visible light is scattered in various directions. The screen 22 in a transmission state functions as a transparent plate having a high transmittance to visible light. The screen 22 in a diffusion state functions as a screen plate that scatters visible light.

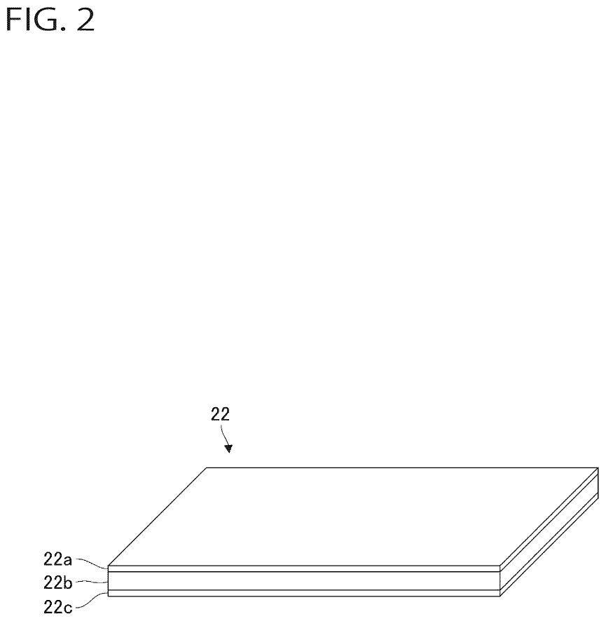

FIG. 2 is a diagram schematically showing an exemplary configuration of the screen 22. The screen 22 includes a first electrode layer 22a, a diffusion layer 22b, and a second electrode layer 22c and has a structure in which they are layered. The first electrode layer 22a and the second electrode layer 22c are made of a material transparent to visible light and is made of, for example, a transparent conductive material such as indium tin oxide (ITO; Indium Tin Oxide). The diffusion layer 22b is configured to switch between a transmission state and a diffusion state depending on whether a voltage is applied between the first electrode layer 22a and the second electrode layer 22c. The diffusion layer 22b is made of, for example, an electrochromic material or a liquid crystal material.

Returning back to FIG. 1, the irradiation unit 14 is configured to irradiate the display body 12 with the image display light 24. The irradiation unit 14 radiates the image display light 24 in the direction of layering of the plurality of screens 22. The image display light 24 radiated from the irradiation unit 14 is light transmitted through the screen 22 in a transmission state and scattered by the screen 22 in a diffusion state. As a result, an image corresponding to the display content of the image display light 24 is displayed on the screen 22 in a diffusion state.

The irradiation unit 14 is, for example, a projector, and includes a light source that generates an illumination light, an image display element that generates the image display light 24 by modulating the illumination light from the light source, and a projection optical system that projects the image display light 24. The image display element may be a transmissive display element such as a liquid crystal panel or may be a reflective display element such as a DMD (Digital Mirror Device) and an LCOS (Liquid Crystal on Silicon). The irradiation unit 14 may be a laser scanning projector that generates the image display light 24 by scanning a laser beam in two dimensions. In this case, the image display element of the irradiation unit 14 may be an LSM (Laser Scanning Module) of MEMS (Micro Electro Mechanical Systems), etc.

The sensor 16 detects an observer 26 observing the display body 12. The sensor 16 is, for example, provided at a position distanced from the display body 12 in the z direction and detects the observer 26 located around the display body 12. The sensor 16 is, for example, an all-sky camera capable of capturing the display body 12 and the space 360 degrees around the display body 12 and detects the position of the observer 26 with respect to the display body 12 by referring to the arrangement of the display body 12 and the observer 26 included in an image captured by the all-sky camera. The sensor 16 detects position coordinates of the observer 26 in a coordinate system (e.g., x direction, y direction, and z direction) defined with reference to the center of the display body 12. The sensor 16 may be comprised of a plurality of sensors provided at a plurality of positions or may be comprised of, for example, a plurality of cameras with different positions and angles of view.

The sensor 16 may be configured to further detect a viewpoint position 26a and a viewing direction 26b of the observer 26. The viewpoint position 26a of the observer 26 is the midpoint between both eyes when both eyes of the observer 26 are detected and is the position of the detected single eye when only one eye of the observer 26 is detected. The viewing direction 26b of the observer 26 can be identified by detecting the orientation of the eye of the observer 26 using a known technique. The orientation of the eye of the observer 26 can be detected based on, for example, a positional difference between a moving point such as the iris or pupil of the eyeball that moves when the eyeball is moved, and a fixed point such as the inner corner of the eye or outer corner of the eye that does not move even if the eyeball is moved.

The control unit 18 controls the overall operation of the display apparatus 10. Various functions provided by the control unit 18 can be realized by, for example, by cooperation between hardware and software. The hardware of the control unit 18 is realized by elements such as a processor and a memory provided in a computer or a mechanical apparatus. The software of the control unit 18 is realized by a program, etc. executed by the processor.

The external apparatus 20 is an information processing apparatus capable of generating three-dimensional data. Like the control unit 18, the external apparatus 20 can be realized by cooperation between hardware and software. The hardware of the external apparatus 20 can be realized by elements such as a processor and a memory provided in a computer or a mechanical apparatus, and the software of the external apparatus 20 can be realized by a program executed by the processor, etc.

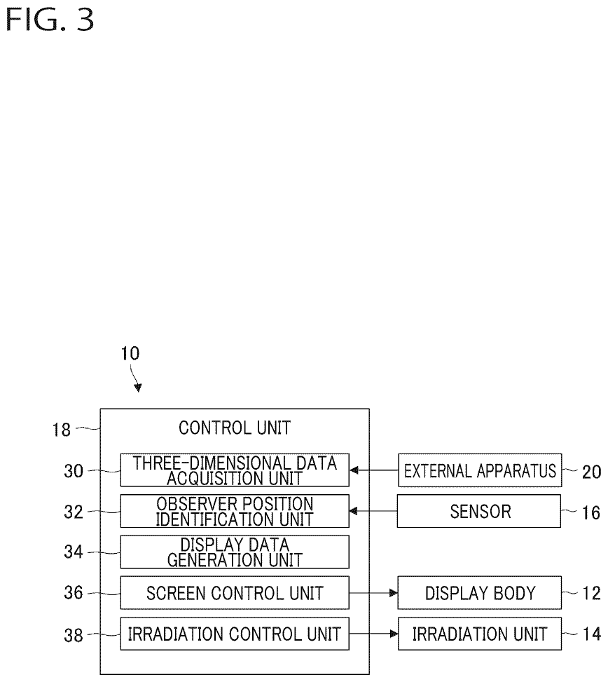

FIG. 3 is a block diagram schematically showing an exemplary functional configuration of the control unit 18. The control unit 18 includes a three-dimensional data acquisition unit 30, an observer position identification unit 32, a display data generation unit 34, a screen control unit 36, and an irradiation control unit 38.

The three-dimensional data acquisition unit 30 acquires three-dimensional data from the external apparatus 20. The three-dimensional data acquired from the external apparatus 20 is data for identifying the three-dimensional shape of the stereoscopic image S that should be displayed on the display body 12. The three-dimensional data may be stereoscopic outline image data that designates the three-dimensional position and display color of the outline of the stereoscopic image S. The three-dimensional data may be moving image data and may include frame data for drawing frames of the stereoscopic image S that forms moving images.

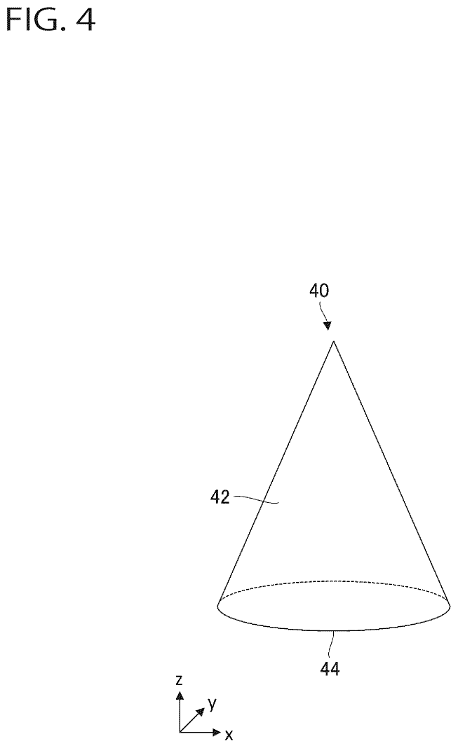

FIG. 4 is a diagram schematically showing exemplary three-dimensional data and shows a case where the stereoscopic image S that should be displayed on the display body 12 is a cone 40. The three-dimensional data includes data for designating the three-dimensional position and display color of a conical surface (or side surface) 42 and a bottom surface 44 that define the outline of the cone 40. The three-dimensional data is defined by using, for example, a coordinate system (e.g., x direction, y direction, and z direction) defined with reference to the center of the display body 12.

Referring back to FIG. 3, the observer position identification unit 32 identifies the position of the observer 26 using information acquired from the sensor 16. When the sensor 16 is a camera, for example, the observer position identification unit 32 acquires an image captured by the sensor 16 and identifies the position of the observer 26 from the captured image thus acquired. The observer position identification unit 32 may acquire position coordinates of the observer 26 detected by the sensor 16 from the sensor 16. The observer position identification unit 32 may identify the viewpoint position 26a of the observer 26 or may identify the viewing direction 26b of the observer 26.

The display data generation unit 34 generates display data for displaying the stereoscopic image S using the three-dimensional data acquired by the three-dimensional data acquisition unit 30 and the position of the observer 26 identified by the observer position identification unit 32. The display data generated by the display data generation unit 34 is used to control the operation of the display body 12 and the irradiation unit 14.

The display data generation unit 34 maps the three-dimensional shape of the stereoscopic image S based on the three-dimensional data and the position of the observer 26 in the coordinate system defined with reference to the center of the display body 12 and identifies an outline portion of the stereoscopic image S that is visible from the position of the observer 26. Stated otherwise, the display data generation unit 34 identifies an outline portion of the stereoscopic image S that is invisible from the position of the observer 26. An outline portion that is visible is a portion of the outline of the stereoscopic image S that faces the observer 26 and is a display portion that should be displayed as the stereoscopic image S. Meanwhile, an outline portion that is invisible is a portion that is shielded from view by the display portion when viewed from the observer 26 and is a non-display portion that should not be displayed as the stereoscopic image S.

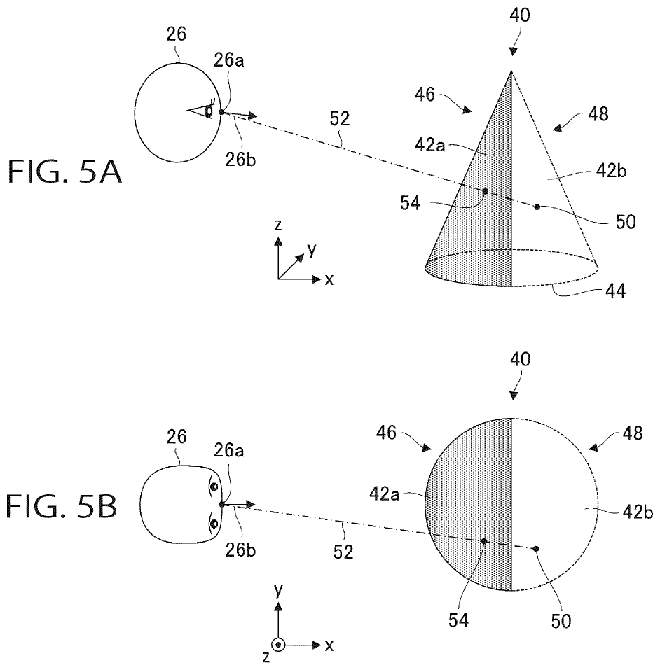

FIGS. 5A and 5B are diagrams schematically showing examples of a display portion 46 and a non-display portion 48 and show a case where the stereoscopic image S is the cone 40 shown in FIG. 4. FIG. 5A is a perspective view corresponding to FIG. 1 and FIG. 5B is a corresponding top view from the sensor 16 of FIG. 1. In the examples of FIGS. 5A and 5B, the observer 26 is located on the side of the cone 40 in the −x direction, and the viewing direction 26b of the observer 26 is oriented in the +x direction toward the cone 40. A half cone surface 42a on the side of the cone 40 in the −x direction is the display portion 46 visible from the viewpoint position 26a of the observer 26. Meanwhile, a half cone surface 42b on side of the cone 40 in the +x direction and the bottom surface 44 of the cone 40 are non-display portions 48 that are invisible from the viewpoint position 26a of the observer 26. The non-display portion 48 is a portion that is shielded from view by the display portion 46 when viewed from the viewpoint position 26a of the observer 26.

For example, the display data generation unit 34 sets a line segment 52 between a coordinate point 50 indicating a three-dimensional position of an outline portion of the cone 40 and the viewpoint position 26a and determines whether an outline portion of the cone 40 is located on the line segment 52. When an outline portion of the cone 40 is not located on the line segment 52, the coordinate point 50 is defined as the display portion 46. When an outline portion of the cone 40 is located on the line segment 52, the coordinate point 50 is defined as the non-display portion 48. The display data generation unit 34 examines all coordinate points indicating three-dimensional positions of the outline portions of the cone 40 and determines whether the coordinate points are the display portion 46 or the non-display portion 48. In the example shown in FIGS. 5A and 5B, there is another coordinate point 54 that is the display portion 46 on the line segment 52. Therefore, the coordinate point 50 subject to determination will be the non-display portion 48.

The display data generation unit 34 may determine whether a coordinate point is the display portion 46 or the non-display portion 48 in consideration of the range covered by the field of view of the observer 26. The display data generation unit 34 may define, for example, only those coordinate points located on the line segment 52 extending from the viewpoint position 26a in a particular direction as candidates of the display portion 46 and may define all coordinate points located on the line segment 52 extending in a direction different from the particular direction as the non-display portions 48. The particular direction is a direction in a predetermined angular range in the vertical direction and in the horizontal direction around the viewing direction 26b of the observer 26. For example, a range of 60 degrees upward, 70 degrees downward, 60 degrees leftward, and 60 degrees rightward with respect to the viewing direction 26b may define the particular direction, based on the ordinary field of view of human beings.

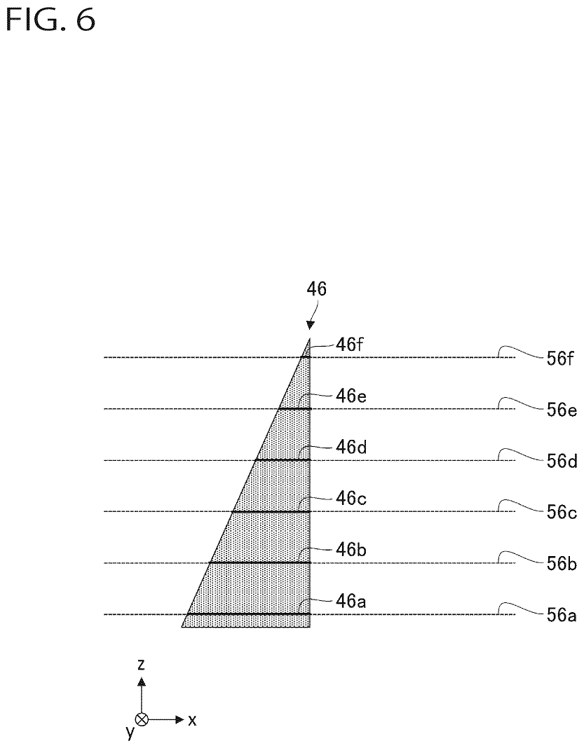

FIG. 6 is a diagram schematically showing a method for generating cross-sectional image data. The display data generation unit 34 generates a plurality of items of cross-sectional image data from three-dimensional data comprised only of the display portion 46. The display data generation unit 34 generates cross-sectional image data indicating the shape of cross-sectional portions 46A-46F of the display portion 46 in a plurality of xy planes 56A-56F corresponding to the z-coordinate positions of the plurality of screens 22. The plurality of items of cross-sectional image data are display data for displaying images that should be projected respectively to the plurality of screens 22.

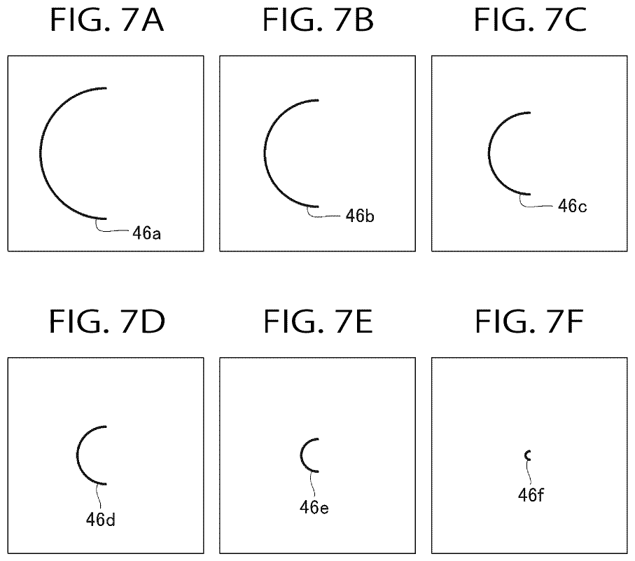

FIGS. 7A-7F are diagrams schematically showing examples of cross-sectional images and show cross-sectional images corresponding respectively to the xy planes 56A-56F of FIG. 6. As shown in FIGS. 7A-7F, the cross-sectional portions 46a-46f included respectively in the plurality of cross-sectional images have an arc shape corresponding to the display portion 46 corresponding to a half of the cone surface 42.

Referring back to FIG. 3, the screen control unit 36 controls the operation of the plurality of screens 22 provided in the display body 12. The screen control unit 36 places one of the plurality of screens 22 in a diffusion state and places the remaining screens 22 in a transmission state. The screen control unit 36 switches the screen 22 to be in the diffusion state and controls each of the plurality of screens 22 so that they are in a diffusion state at different points of time in turn.

The irradiation control unit 38 controls the operation of the irradiation unit 14. The irradiation control unit 38 controls the display content of the image display light 24 radiated from the irradiation unit 14 using the display data generated by the display data generation unit 34. The irradiation control unit 38 switches the display content of the image display light 24 in synchronization with the operation of the screen control unit 36 so that each of the plurality of screens 22 is irradiated with the image display light 24 of the corresponding display content. The irradiation control unit 38 switches the display content of the image display light 24 radiated from the irradiation unit 14 using the plurality of items of cross-sectional image data generated by the display data generation unit 34 in synchronization with switching between a transmission state and a diffusion state of each of the plurality of screens 22.

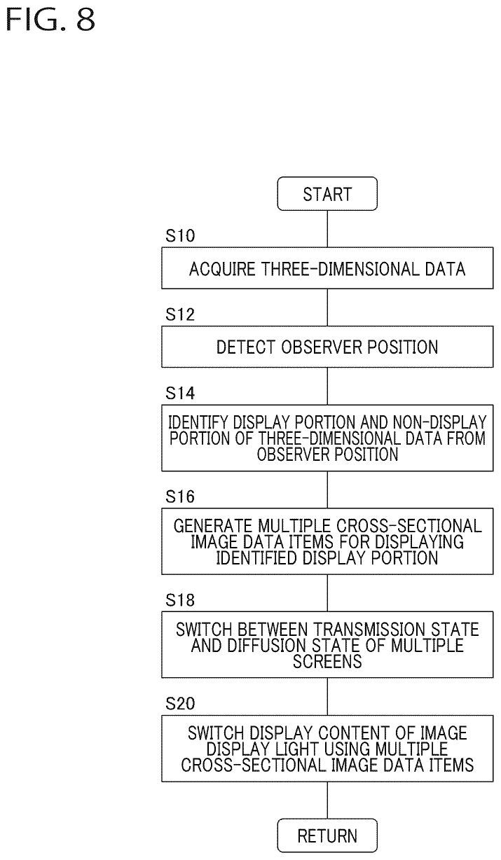

FIG. 8 is a flowchart illustrating an exemplary display method according to the first embodiment. The three-dimensional data acquisition unit 30 acquires three-dimensional data from the external apparatus 20 (S10). The observer position identification unit 32 uses the sensor 16 to detect the position of the observer 26 with respect to the display body 12 (S12). The display data generation unit 34 identifies the display portion 46 and the non-display portion 48 of the three-dimensional data by referring to the detected position of the observer 26 (S14) and generates a plurality of items of cross-sectional image data for displaying the identified display portion 46 (S16). The screen control unit 36 switches between a transmission state and a diffusion state of the plurality of screens 22 constituting the display body 12 (S18). The irradiation control unit 38 switches the display content of the image display light 24 radiated from the irradiation unit 14 using the plurality of items of cross-sectional image data generated by the display data generation unit 34 (S20).

The control unit 18 synchronously controls switching of the state of the plurality of screens 22 by the screen control unit 36 (S18) and switching of the display content of the image display light 24 by the irradiation control unit 38 (S20). The cycle for switching the state of the plurality of screens 22 is, for example, about several milliseconds, and the time required to switch all of the plurality of screens 22 is, for example, about several tens of milliseconds-several hundreds of milliseconds. Thereby, the display content displayed on each of the plurality of screens 22 in a time-divided manner is viewed by the observer 26 simultaneously as afterimages, and the stereoscopic image S is generated on the display body 12. The irradiation control unit 38 controls the display content of the image display light 24 so as to display only the portion the three-dimensional data acquired from the external apparatus 20 that should be visible from the observer 26 as the stereoscopic image S. Thereby, the stereoscopic image S can be displayed such that the back side of the stereoscopic image S cannot be seen through from the observer 26.

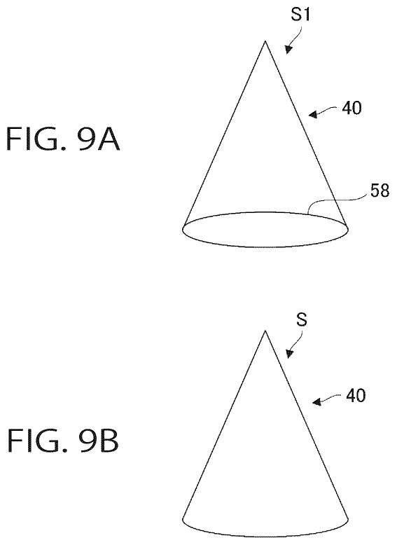

FIG. 9A is a display example of a stereoscopic image S1 viewed from the observer 26 according to a comparative example, and FIG. 9B is a display example of the stereoscopic image S viewed from the observer 26 according to the embodiment. In the comparative example of FIG. 9A, the display portion 46 is not identified using the position of the observer 26, and the entire three-dimensional data acquired from the external apparatus 20 is displayed as the stereoscopic image S1. In the comparative example of FIG. 9A, the non-display portion 48 is also displayed as the stereoscopic image S1 so that a portion 58 that is on the back side of the cone 40 can be seen through from the observer 26. In the embodiment of FIG. 9B, on the other hand, the display data for only the display portion 46 is used, realizing a display mode in which the back side of the cone 40 is not displayed, and the back side of the cone 40 cannot be seen through from the observer 26.

The control unit 18 may acquire three-dimensional data corresponding to each frame of moving image data from the external apparatus 20 and display different stereoscopic images S for different frames. Thereby, the stereoscopic image S forming moving images can be displayed. When the position of the observer 26 changes, the control unit 18 displays the stereoscopic image S, dynamically changing the portion of the three-dimensional data that is the display portion 46. Thereby, a display mode can be realized in which the back side of the stereoscopic image S cannot be seen through when viewed from the observer 26 even when the position of the observer 26 changes.

### Second Embodiment

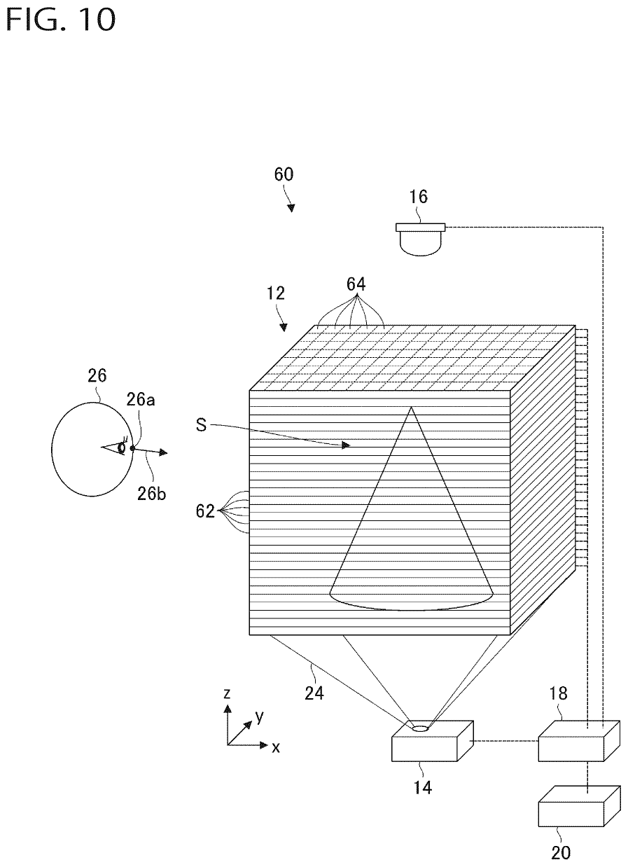

FIG. 10 is a diagram schematically showing a configuration of a display apparatus 60 according to the second embodiment. The second embodiment differs from the first embodiment in that each of a plurality of screens 62 has a pixel structure. The following description of the second embodiment highlights the difference from the first embodiment, and a description of common features is omitted as appropriate.

The display apparatus 60 includes a display body 12, an irradiation unit 14, a sensor 16, and a control unit 18. The irradiation unit 14, the sensor 16, and the control unit 18 may be configured in the same manner as the first embodiment.

The display body 12 is comprised of a plurality of screens 62 layered in the z direction. The screen 62 includes a plurality of pixels 64 arranged in the in-plane direction (x direction and y direction). The screen 62 is configured to be switchable between a transmission state and a diffusion state pixel 64 by pixel 64. The screen 62 is configured such that some of the pixels 64 can be selectively switched to a diffusion state.

According to the second embodiment, the pixel structure of the screen 62 makes it possible to display the display content of the image display light 24 on the screen 62 by selectively placing some pixels 64 corresponding to the display content of the image display light 24 radiated from the irradiation unit 14 in a diffusion state. According to the second embodiment, two or more screens 62 out of the plurality of screens 62 can be simultaneously irradiated with the image display light 24, and the display content of the image display light 24 can be displayed simultaneously on the two or more screens 62. In each of the two or more screens 62, at least one pixel 64 at a position that does not overlap in the irradiation direction of the image display light 24 is simultaneously placed in a diffusion state.

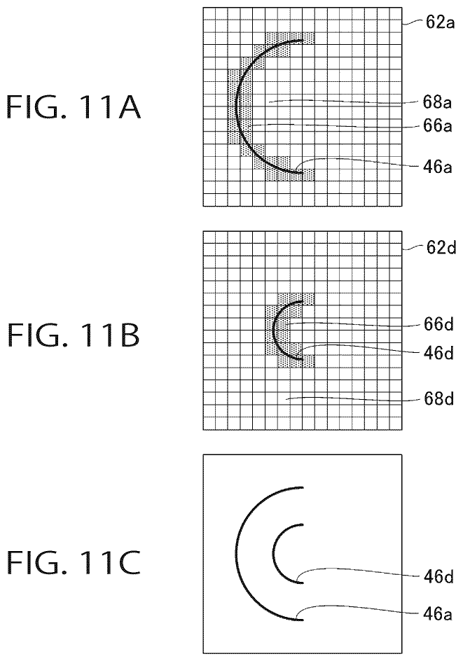

FIGS. 11A-11C are diagrams schematically showing a display method according to the second embodiment and show a case where the pixels 66a, 66d of the two or more screens 62a, 62d are simultaneously placed in a diffusion state.

FIG. 11A shows an example of control a first screen 62a corresponding to the first plane 56a of FIG. 6. In the first screen 62a, a pixel 66a overlapping the first cross-sectional portion 46a is placed in a diffusion state, and a pixel 68a not overlapping the first cross-sectional portion 46a is placed in a transmission state. FIG. 11B shows an example of control a fourth screen 62d corresponding to the fourth plane 56d of FIG. 6. In the fourth screen 62d, a pixel 66d overlapping the fourth cross-sectional portion 46d is placed in a diffusion state, and a pixel 68d not overlapping the fourth cross-sectional portion 46d is placed in a transmission state.

In this case, the pixel 66a placed in a diffusion state in the first screen 62a does not overlap the pixel 66d placed in a diffusion state in the fourth screen 62d in the direction of layering (z direction). That is, the pixel 66a of the first screen 62a in a diffusion state overlaps the pixel 68d of the fourth screen 62d in a transmission state in the direction of layering (z direction). Similarly, the pixel 66d of the fourth screen 62d in a diffusion state overlaps the pixel 68a of the first screen 62a in a transmission state in the direction of layering (z direction).

FIG. 11C shows the display content of the image display light 24 radiated to the first screen 62a and the fourth screen 62d. The display content of FIG. 11C is an image in which the first cross-sectional portion 46a that should be displayed on the first screen 62a and the fourth cross-sectional portion 46d that should be displayed on the fourth screen 62d are superimposed. The first cross-sectional portion 46a is displayed in the pixel 66a of the first screen 62a in a diffusion state. The fourth cross-sectional portion 46d is transmitted through the pixel 68a of the first screen 62a in a transmission state and is displayed in the pixel 66d of the fourth screen 62d in a diffusion state.

In the example shown in FIGS. 11A-11C, a case where the first cross-sectional portion 46a and the fourth cross-sectional portion 46d of FIG. 6 are displayed simultaneously is shown. By exercising similar control, the second cross-sectional portion 46b and the fifth cross-sectional portion 46e of FIG. 6 can be displayed simultaneously, and the third cross-sectional portion 46c and the sixth cross-sectional portion 46f of FIG. 6 can be displayed simultaneously. By displaying content on two or more screens 62 of the plurality of screens 62 simultaneously in this way, the time required for display on all of the plurality of screens 62 can be shortened, and the frame rate for updating the display of the stereoscopic image S can be increased. By displaying content on two screens 62 simultaneously, for example, the frame rate for updating the display of the stereoscopic image S can be doubled.

In the second embodiment, the display data generation unit 34 generates pixel pattern data for controlling the state of the plurality of pixels 64 of the screen 62. The pixel pattern data determines which of the plurality of pixels 64 should be in a diffusion state and which should be in a transmission state. For example, pixel pattern data that defines the pixel 66a IN a diffusion state and the pixel 68a in a transmission state shown in FIG. 11A is generated for the first screen 62a. The pixel pattern data can be generated using the cross-sectional image data described in the first embodiment. The pixel pattern data can define, for example, that a pixel at a location where the display portion 46 is found in the cross-sectional image data is in a diffusion state, and a pixel at a location where the display portion 46 is not found is in a transmission state.

Of a plurality of items of pixel pattern data corresponding to the plurality of screens 62, the display data generation unit 34 determines a combination of two or more items of pixel pattern data in which pixels in a diffusion state do not overlap each other. The display data generation unit 34 determines, for example, a combination of the pixel pattern data for the first screen 62a of FIG. 11A and the pixel pattern data for the fourth screen 62d of FIG. 11B. The display data generation unit 34 may determine a combination so that the number of combinations of pixel pattern data is minimized. In this case, the time required for display on all of the plurality of screens 62 can be further reduced. The display data generation unit 34 may include three or more items of pixel pattern data in one combination. Further, the pixel pattern data, for which a combination in which pixels in a diffusion state do not overlap each other cannot be found, may remain by itself without being combined with other pixel pattern data.

The display data generation unit 34 generates display image data for controlling the display content of the image display light 24 radiated from the irradiation unit 14 based on the combination of pixel pattern data. The display data generation unit 34 generates display image data by superimposing a plurality of items of cross-sectional image data corresponding to the combination of pixel pattern data. The display data generation unit 34 generates display image data corresponding to the display content of FIG. 11C based on, for example, the combination of the pixel pattern data for the first screen 62a of FIG. 11A and the pixel pattern data of the fourth screen 62D of FIG. 11B. The display image data corresponding to FIG. 11C is generated by superimposing the first cross-sectional image data corresponding to the display content of the first screen 62a and the fourth cross-sectional image data corresponding to the display content of the fourth screen 62d.

The screen control unit 36 controls switching between a transmission state and a diffusion state of the plurality of pixels 64 of the plurality of screens 62 based on the combination of pixel pattern data. When two or more items of pixel pattern data are included in one combination, the screen control unit 36 switches at least one pixel 64 included in each of the corresponding two or more screens 62 to a diffusion state based on the pixel pattern data. The screen control unit 36 controls the pixel pattern of each of the plurality of screens 62 in a time-divided manner by switching the combination of pixel pattern data in sequence.

The irradiation control unit 38 switches the display content of the image display light 24 in synchronization with the operation of the screen control unit 36. The irradiation control unit 38 controls the display content of the image display light 24 radiated from the irradiation unit 14 using the display image data generated in accordance with the combination of pixel pattern data. The irradiation control unit 38 controls the display content of each of the plurality of screens 62 in a time-divided manner by switching the display image data in sequence.

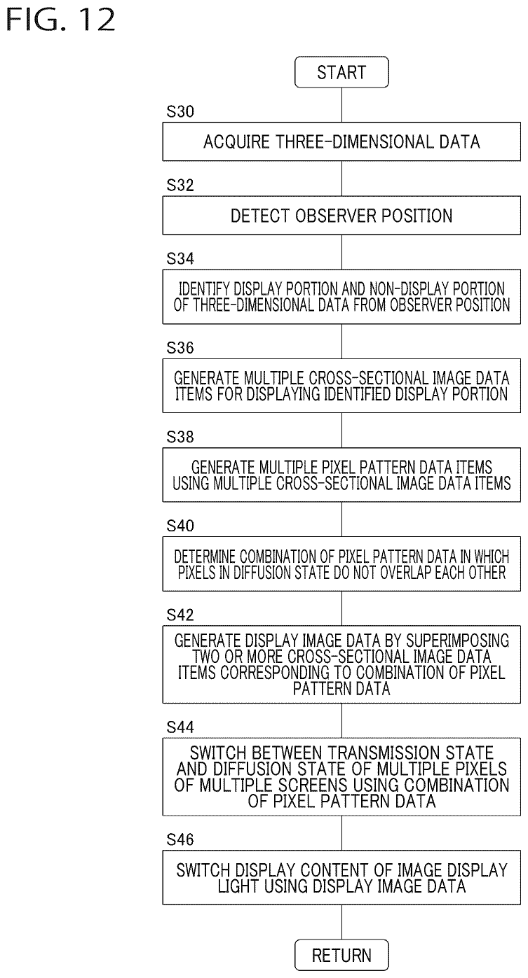

FIG. 12 is a flowchart showing an exemplary display method according to the second embodiment. The three-dimensional data acquisition unit 30 acquires three-dimensional data from the external apparatus 20 (S30). The observer position identification unit 32 uses the sensor 16 to detect the position of the observer 26 with respect to the display body 12 (S32). The display data generation unit 34 identifies the display portion 46 and the non-display portion 48 of the three-dimensional data by referring to the detected position of the observer 26 (S34) and generates a plurality of items of cross-sectional image data for displaying the identified display portion 46 (S36).

The display data generation unit 34 generates a plurality of items of pixel pattern data that defines the diffusion state and the transmission state of the plurality of pixels 64 of the plurality of screens 62 using the plurality of items of cross-sectional image data (S38). Of the plurality of items of pixel pattern data, the display data generation unit 34 determines a combination of pixel pattern data in which pixels in a diffusion state do not overlap each other (S40). The display data generation unit 34 generates display image data by superimposing two or more items of cross-sectional image data corresponding to the combination of pixel pattern data (S42).

The screen control unit 36 switches between a transmission state and a diffusion state of the plurality of pixels 64 of the plurality of screens 22 using the combination of pixel pattern data generated by the display data generation unit 34 (S44). The irradiation control unit 38 switches the display content of the image display light 24 radiated from the irradiation unit 14 using the plurality of items of cross-sectional image data generated by the display data generation unit 34 (S46).

The control unit 18 synchronously controls switching of the state of the plurality of pixels of the plurality of screens 62 by the screen control unit 36 (S44) and switching of the display content of the image display light 24 by the irradiation control unit 38 (S46), thereby displaying the stereoscopic image S such that the back side of the stereoscopic image S cannot be seen through from the observer 26. In this process, the image display light 24 can be radiated to two or more screens 62 simultaneously by combining two or more items of pixel pattern data, and the image display light 24 may be radiated to all of the plurality of screens 62 to reduce the time required to display the stereoscopic image S.

### Third Embodiment

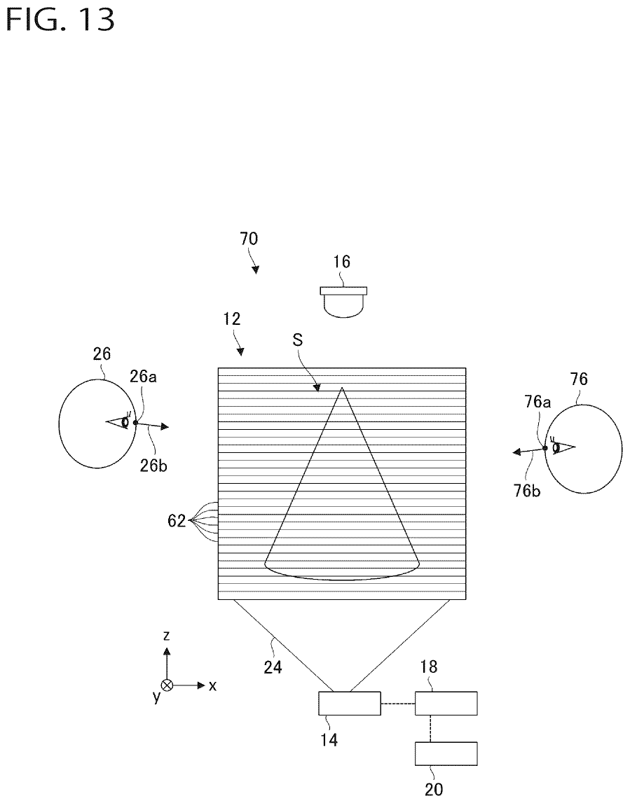

FIG. 13 is a diagram schematically showing a configuration of a display apparatus 70 according to the third embodiment. The following description of the third embodiment highlights the difference from the second embodiment described above. A description of common features is omitted as appropriate.

The display apparatus 70 includes a display body 12, an irradiation unit 14, a sensor 16, and a control unit 18. As in the second embodiment, the display body 12 includes a plurality of screens 62 having a pixel structure. The irradiation unit 14, the sensor 16, and the control unit 18 may be configured in the same manner as the first embodiment.

The sensor 16 detects the position a plurality of observers 26, 76. The sensor 16 is, for example, configured to detect the viewpoint position 26a and the viewing direction 26b of the first observer 26 and also detect a viewpoint position 76a and a viewing direction 76b of the second observer 76. In the example shown in FIG. 13, two observers are detected simultaneously, but three or more observers may be detected simultaneously.

In the third embodiment, a display mode is realized in which the back side of the stereoscopic image S is difficult to be seen through from a plurality of observers 26 and 76 located around the display body 12. In the third embodiment, the portion corresponding to the front side of the stereoscopic image S as viewed from the second observer 76 will not be displayed, making it impossible to display an appropriate stereoscopic image S for the second observer 76, if the portion corresponding to the back side of the stereoscopic image S when viewed from the first observer 26 is not displayed. In the third embodiment, therefore, it could be inappropriate not to display a portion of the stereoscopic image S in order to realize a display mode in which the back side of the stereoscopic image S cannot be seen through. In the third embodiment, a display mode is realized in which the back side of the stereoscopic image S is difficult to be seen through by using pixels of the screen 62 in a diffusion state to shield light from the portion corresponding to the back side of the stereoscopic image S as viewed from the plurality of observers 26, 76.

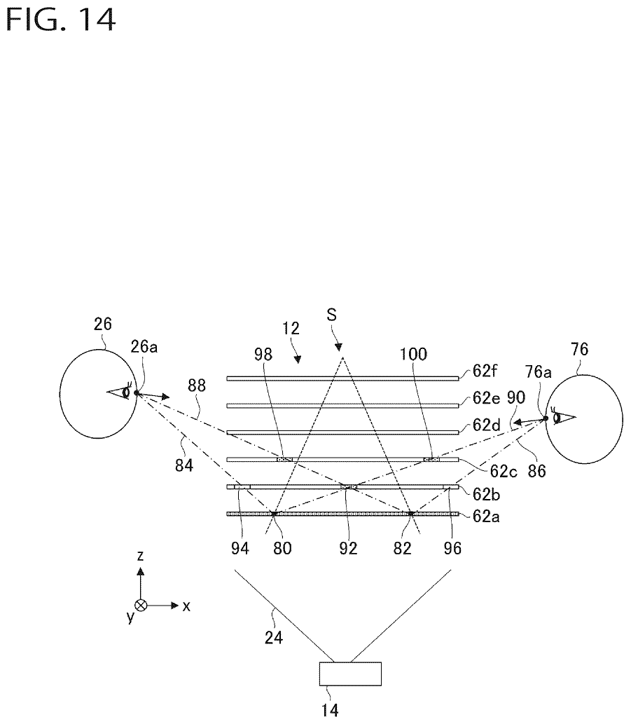

FIG. 14 is a cross-sectional view schematically showing a display method according to the third embodiment. FIG. 14 shows a situation in which the first screen 62a is placed in a diffusion state and the first screen 62a is irradiated with the image display light 24. On the first screen 62a, a first display portion 80 and a second display portion 82, which are outline portions of the stereoscopic image S, are displayed. The first display portion 80 is a portion that is on the front side of the stereoscopic image S as viewed from the first observer 26 and is a portion that is on the back side of the stereoscopic image S as viewed from the second observer 76. The second display portion 82 is a portion that is on the back side of the stereoscopic image S as viewed from the first observer 26 and is a portion that is on the front side of the stereoscopic image S as viewed from the second observer 76.

Referring to FIG. 14, the plurality of screens 62a-62f are controlled to place the pixels on a first straight line 84 from the first display portion 80 toward the first observer 26 in a transmission state so that the first observer 26 can view the first display portion 80. For example, a pixel 94 located at the intersection of the first straight line 84 and the second screen 62b is controlled to be in a transmission state. Similarly, the pixels on a second straight line 86 from the second display portion 82 toward the second observer 76 are controlled to be in a transmission state so that the second observer 76 can view the second display portion 82. For example, a pixel 96 located at the intersection of the second straight line 86 and the second screen 62b is controlled to be in a transmission state.

Referring to FIG. 14, the plurality of screens 62a-62f are controlled to place least one pixel on a third straight line 88 from the second display portion 82 toward the first observer 26 in a diffusion state to make it difficult for the first observer 26 to view the second display portion 82. For example, a pixel 98 located at the intersection of the third straight line 88 and the third screen 62c is controlled to be a diffusion state. Similarly, at least one pixel on a fourth straight line 90 from the first display portion 80 toward the second observer 76 is controlled to be in a diffusion state to make it difficult for the second observer 76 to view the first display portion 80. For example, a pixel 100 located at the intersection of the fourth straight line 90 and the third screen 62c is controlled to be in a diffusion state. A pixel 92 located at the intersection of the third straight line 88, the fourth straight line 90, and the second screen 62b may be controlled to be in a diffusion state. In order to enhance the performance of shielding by the pixels in the diffusion state, the plurality of pixels 92, 98 on the third straight line 88 may be placed in a diffusion state simultaneously, or the plurality of pixels 92, 100 on the fourth straight line 90 may be placed in a diffusion state simultaneously.

In the third embodiment, the display data generation unit 34 identifies the plurality of display portions 80, 82 corresponding to the plurality of observers 26, 76. For example, the display data generation unit 34 identifies a portion that should be displayed as viewed from the first observer 26 as the first display portion 80 and identifies a portion that should be displayed as viewed from the second observer 76 as the second display portion 82. Of the plurality of display portions 80, 82, the display data generation unit 34 identifies a portion that should be shielded from view from the plurality of observers 26, 76. For example, the display portion that is not the first display portion 80 (e.g., the second display portion 82) is identified as the first shielded portion that should be shielded from view from the first observer 26, and the display portion that is not the second display portion 82 (e.g., the first display portion 80) is identified as the second shielded portion that should be shielded from view from the second observer 76.

The display data generation unit 34 generates cross-sectional image data for displaying the plurality of display portions 80, 82 for each of the plurality of screens 62. When one screen 62 is irradiated with the image display light 24 based on cross-sectional image data, the display data generation unit 34 generates pixel pattern data that determines the transmission state the diffusion state of the plurality of pixels 64 of the remaining screens 62. For example, the pixel pattern data for a screen (for example, the second screen 62b and the third screen 62c) different from the first screen 62a is generated as pixel pattern data used when the first screen 62a is irradiated with the image display light 24 based on the first cross-sectional image data. The pixel pattern data for the screen different from the first screen 62a is defined such that the pixels on straight lines extending from the display portions 80, 82 toward the corresponding observers 26, 76 are in a transmission state, and at least one pixel on straight lines extending from the shielded portions 82, 80 toward the corresponding observers 26, 76 is in a diffusion state. For example, the pixels on the straight line extending from the first display portion 80 toward the first observer 26 are in a transmission state, the pixels on the straight line extending from the second display portion 82 toward the second observer 76 are in a transmission state, and at least one pixel on the straight line extending from the first shielded portion 82 toward the first observer 26 is in a diffusion state, and at least one pixel on the straight line extending from the second shielded portion 80 toward the second observer 76 is in a diffusion state.

The screen control unit 36 controls switching between the transmission state and the diffusion state of the plurality of pixels 64 of the plurality of screens 62 based on the pixel pattern data. For example, the screen control unit 36 places all pixels 64 of the screen 62 to be irradiated by the image display light 24 in a diffusion state and controls the transmission state and diffusion state of the plurality of pixels 64 of the screen 62 that is not irradiated based on the pixel pattern data. When the display content of the image display light 24 is displayed on the first screen 62a, for example, at least some of the pixels 64 of the screen 62b-62f different from the first screen 62a are controlled to be in a diffusion state based on the pixel pattern data. Further, when the display content of the image display light 24 is displayed on the second screen 62b, at least some of the pixels 64 of the screens 62a, 62c-62f different from the second screen 62b are controlled to be in a diffusion state based on the pixel pattern data.

The irradiation control unit 38 switches the display content of the image display light 24 in synchronization with the operation of the screen control unit 36. The irradiation control unit 38 controls the display content of the image display light 24 radiated from the irradiation unit 14 using the generated cross-sectional image data. The irradiation control unit 38 controls the display content on each of the plurality of screens 62 by switching the cross-sectional image data in sequence in a time-divided manner.

According to the third embodiment, a display mode is realized in which the back side of the stereoscopic image S is difficult to be seen through by using pixels in a diffusion state to shield or scatter light from the portion that is on the back side of the stereoscopic image S as viewed from the plurality of observers 26, 76.

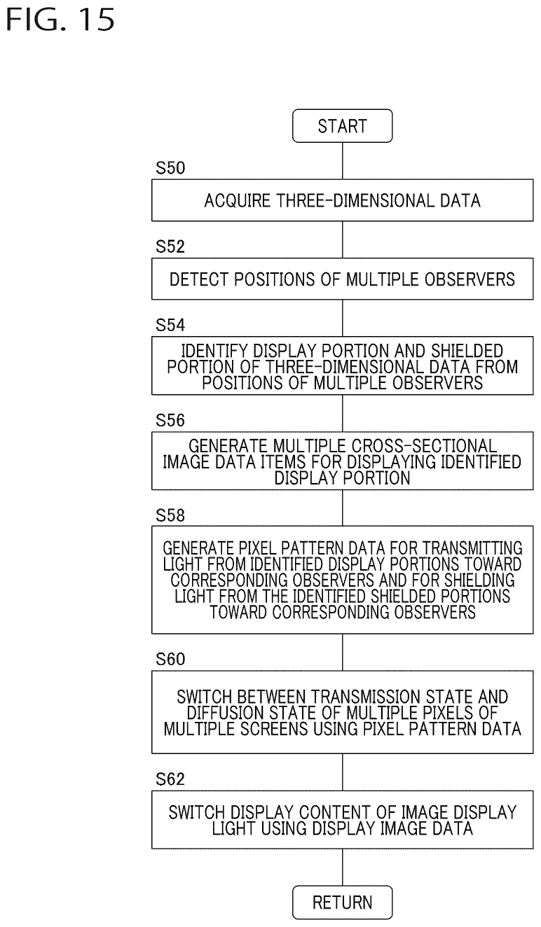

FIG. 15 is a flowchart illustrating an exemplary display method according to the third embodiment. The three-dimensional data acquisition unit 30 acquires three-dimensional data from the external apparatus 20 (S50). The observer position identification unit 32 uses the sensor 16 to detect the positions of the plurality of observers 26, 27 with respect to the display body 12 (S52). The display data generation unit 34 identifies the display portions 80, 82 and the shielded portions 82, 80 of the three-dimensional data by referring to the detected positions of the plurality of observers 26, 76 (S54) and generates a plurality of items of cross-sectional image data for displaying the identified display portions 80, 82 (S56). The display data generation unit 34 generates pixel pattern data for transmitting light from the identified display portions 80, 82 toward the corresponding observers 26, 76 and for shielding light from the identified shielded portions 82, 80 toward the corresponding observers 26, 76 (S58). The screen control unit 36 switches between a transmission state and a diffusion state of the plurality of pixels 64 of the plurality of screens 62 based on the pixel pattern data generated by the display data generation unit 34 (S60). The irradiation control unit 38 switches the display content of the image display light 24 radiated from the irradiation unit 14 using the display image data generated by the display data generation unit 34 (S62). The control unit 18 synchronously controls switching of the state of the plurality of pixels 64 of the plurality of screens 62 by the screen control unit 36 (S60) and switching of the display content of the image display light 24 by the irradiation control unit 38 (S62). Thereby, the stereoscopic image S can be displayed such that the back side of the stereoscopic image S is difficult to be seen through from the plurality of observers 26, 76.

The present disclosure has been explained with reference to the embodiments described above, but the present disclosure is not limited to the embodiments described above, and appropriate combinations or replacements of the features shown in the examples presented are also encompassed by the present disclosure.

Embodiments of the present disclosure are as defined below clauses:

1. A display apparatus including:
a display body in which a plurality of screens switchable between a transmission state that transmits light and a diffusion state that diffuses light are layered;
an irradiation unit that radiates an image display light toward the display body;
a sensor that detects a position of an observer with respect to the display body; and
a control unit that synchronously controls switching between a transmission state and a diffusion state of each of the plurality of screens and switching of a display content of the image display light radiated from the irradiation unit in accordance with the position of the observe detected by the sensor.

2. A display apparatus including:
a display body in which a plurality of screens are layered, each of the plurality of screens including a plurality of pixels arranged in an in-plane direction, and each of the plurality of pixels being switchable between a transmission state and a diffusion state;
an irradiation unit that radiates an image display light toward the display body;
a sensor that detects a position of an observer with respect to the display body; and
a control unit that synchronously controls switching between a transmission state and a diffusion state of each of the plurality of pixels of the plurality of screens and switching of a display content of the image display light radiated from the irradiation unit in accordance with the position of the observer detected by the sensor.

3. The display apparatus according to clause 2, wherein the control unit places at least one pixel included in each of two or more screens of the plurality of screens in a diffusion state simultaneously in accordance with at least one of the position of the observer detected by the sensor and the display content of the image display light radiated from the irradiation unit.

4. A display method including:
detecting, using a sensor, a position of an observer with respect to a display body in which a plurality of screens switchable between a transmission state that transmits light and a diffusion state that diffuses light are layered; and
synchronously controlling switching between a transmission state and a diffusion state of each of the plurality of screens and switching of a display content of an image display light radiated from an irradiation unit toward the display body in accordance with the position of the observe detected by the sensor.

5. A display method including:
detecting, using a sensor, a position of an observer with respect to a display body in which a plurality of screens are layered, each of the plurality of screens including a plurality of pixels arranged in an in-plane direction, and each of the plurality of pixels being switchable between a transmission state and a diffusion state;
synchronously controlling switching between a transmission state and a diffusion state of each of the plurality of pixels of the plurality of screens and switching of a display content of an image display light radiated from an irradiation unit to the display body in accordance with the position of the observer detected by the sensor.

6. A non-transitory recording medium that stores a program, the program including computer-implemented modules including:
a module that detects, using a sensor, a position of an observer with respect to a display body in which a plurality of screens switchable between a transmission state that transmits light and a diffusion state that diffuses light are layered; and
a module that synchronously controls switching between a transmission state and a diffusion state of each of the plurality of screens and switching of a display content of an image display light radiated from an irradiation unit toward the display body in accordance with the position of the observe detected by the sensor.

7. A non-transitory recording medium that stores a program, the program including computer-implemented modules including:
a module that detects, using a sensor, a position of an observer with respect to a display body in which a plurality of screens are layered, each of the plurality of screens including a plurality of pixels arranged in an in-plane direction, and each of the plurality of pixels being switchable between a transmission state and a diffusion state;
a module that synchronously controls switching between a transmission state and a diffusion state of each of the plurality of pixels of the plurality of screens and switching of a display content of an image display light radiated from an irradiation unit to the display body in accordance with the position of the observer detected by the sensor.

What is claimed is:

1. A display apparatus comprising:
a display body in which a plurality of screens are layered, each of the plurality of screens including a plurality of pixels arranged in an in-plane direction, and each of the plurality of pixels being switchable between a transmission state and a diffusion state;
an irradiation unit that radiates an image display light toward the display body;
a sensor that detects positions of a plurality of observers with respect to the display body; and
a control unit that synchronously controls switching between a transmission state and a diffusion state of each of the plurality of pixels of the plurality of screens and switching of a display content of the image display light radiated from the irradiation unit in accordance with the positions of the plurality of observers detected by the sensor,
wherein the control unit:
identifies a first display portion in accordance with the position of a first observer of the plurality of observers and generates display image data for displaying the first display portion identified;
identifies a second shielded portion, which constitutes at least a portion of the first display portion, in accordance with the position of a second observer of the plurality of observers and generates pixel pattern data that defines a position of a pixel in each of the plurality of screens in a diffusion state so that a pixel in a diffusion state is not located between the first observer and the first display portion and a pixel in a diffusion state is located between the second observer and the second shielded portion;
controls the display content of the image display light radiated from the irradiation unit using the display image data; and
controls switching between a transmission state and a diffusion state of each of the plurality of pixels of the plurality of screens using the pixel pattern data.

2. The display apparatus according to claim 1,
wherein the control unit:
identifies a second display portion and generates the display image data for further displaying the second display portion identified; and
identifies a first shielded portion, which constitutes at least a portion of the second display portion, in accordance with the position of the first observer and generates the pixel pattern data so that a pixel in a diffusion state is not located between the second observer and the second display portion and a pixel in a diffusion state is located between the first observer and the first shielded portion.

3. The display apparatus according to claim 2,
wherein the control unit generates the pixel pattern data so that a pixel in a diffusion state is located at an intersection of a straight line from the first shielded portion toward the first observer and a straight line from the second shielded portion toward the second observer.

4. The display apparatus according to claim 1,
wherein the control unit places at least one pixel included in each of two or more screens of the plurality of screens in a diffusion state simultaneously.

5. A display method comprising:
detecting, using a sensor, positions of a plurality of observers with respect to a display body in which a plurality of screens are layered, each of the plurality of screens including a plurality of pixels arranged in an in-plane direction, and each of the plurality of pixels being switchable between a transmission state and a diffusion state; and
synchronously controlling switching between a transmission state and a diffusion state of each of the plurality of pixels of the plurality of screens and switching of a display content of an image display light radiated from an irradiation unit toward the display body in accordance with the positions of the plurality of observers detected by the sensor,
the controlling includes:
identifying a first display portion in accordance with the position of a first observer of the plurality of observers and generating display image data for displaying the first display portion identified;
identifying a second shielded portion, which constitutes at least a portion of the first display portion, in accordance with the position of a second observer of the plurality of observers and generating pixel pattern data that defines a position of a pixel in each of the plurality of screens in a diffusion state so that a pixel in a diffusion state is not located between the first observer and the first display portion and a pixel in a diffusion state is located between the second observer and the second shielded portion;
controlling the display content of the image display light radiated from the irradiation unit using the display image data; and
controlling switching between a transmission state and a diffusion state of each of the plurality of pixels of the plurality of screens using the pixel pattern data.

6. A non-transitory recording medium that stores a program, the program comprising computer-implemented modules including:
a module that detects, using a sensor, positions of a plurality of observers with respect to a display body in which a plurality of screens are layered, each of the plurality of screens including a plurality of pixels arranged in an in-plane direction, and each of the plurality of pixels being switchable between a transmission state and a diffusion state; and
a module that synchronously controls switching between a transmission state and a diffusion state of each of the plurality of pixels of the plurality of screens and switching of a display content of an image display light radiated from an irradiation unit toward the display body in accordance with the positions of the plurality of observers detected by the sensor,
the module that controls includes:
a module that identifies a first display portion in accordance with the position of a first observer of the plurality of observers and generates display image data for displaying the first display portion identified;
a module that identifies a second shielded portion, which constitutes at least a portion of the first display portion, in accordance with the position of a second observer of the plurality of observers and generates pixel pattern data that defines a position of a pixel in each of the plurality of screens in a diffusion state so that a pixel in a diffusion state is not located between the first observer and the first display portion and a pixel in a diffusion state is located between the second observer and the second shielded portion;
a module that controls the display content of the image display light radiated from the irradiation unit using the display image data; and
a module that controls switching between a transmission state and a diffusion state of each of the plurality of pixels of the plurality of screens using the pixel pattern data.
